(19) United States
(12) Patent Application Publication
(10) Pub. No.: US 2009/0060693 A1
(43) Pub. Date: Mar. 5, 2009

(54) Working Device and Working Method with Robot

(75) Inventors: Kaname Takahashi, Tokyo (JP); Yoshiharu Hatsusaka, Tokyo (JP); Katsuhiko Ebisawa, Tokyo (JP)

Correspondence Address: BIRCH STEWART KOLASCH & BIRCH, PO BOX 747, FALLS CHURCH, VA, 22040-0747, US

(73) Assignee: HONDA MOTORS CO., LTD., Tokyo (JP)

(21) Appl. No.: 12/224,052

(22) PCT Filed: Feb. 20, 2007
(86) PCT No.: PCT/JP2007/053456

§ 371 Date: Sep. 8, 2008

(30) Foreign Application Priority Data
Feb. 24, 2006 (JP) 2006-048478

(51) Int. Cl. G05B 19/418; B25J 13/00

(52) U.S. Cl. 414/222.02; 414/225.01; 901/49

(57) ABSTRACT

Provided is a working device wherein an operator is not required to enter a working area (K) of a robot (11) surrounded by a protection fence (21). The working device is provided with a tray (43) for placing a second work piece (18). The second work piece is placed on the tray (43) and transferred from inside to the outside of the protection fence.

### TECHNICAL FIELD

The present invention relates to a working device comprised of a robot and a protection fence surrounding the robot, and to a working method.

### BACKGROUND ART

A robot is a useful automated machine that can save labor. A condition is established such that robot operation must be stopped in order for a person to enter a working area of the robot. When the robot is stopped, however, productivity is reduced. A working device that can reduce the frequency with which the robot is stopped is shown in, for example, Japanese Patent Application Laid-Open Publication No. 2004-54916. This working device will be described based on FIG. 5.

A working device 100 shown in FIG. 5 comprises a robot 101; a first container 102 and a second container 103 that are disposed in a working area W of the robot 101 and carry a work; a protection fence 104 that surrounds the first container 102, the second container 103, and the robot 101; a first door 104a and a second door 104b that are closeably provided to a part of the protection fence 104; and work delivery areas 105, 106 established outside of the first door 104a and the second door 104b for placing the first container 102 and the second container 103.

The working area W is also provided with a first sensor 107 between the robot 101 and the first container 102, and a second sensor between the robot 101 and the second container 103.

A first opening sensor 111 for detecting the opening or closing of the first door 104a is provided to the first door 104a; and a second opening sensor 112 for detecting the opening or closing of the second door 104b is provided to the second door 104b. Reference symbol 113 is an indicator lamp which indicates that working is possible via the first door; 114 is an indicator lamp which indicates that working is possible via the second door; and 115 is a slider that serves to convey the processed work from the inside of the working area W to the outside.

The working performed by the working device 100 will subsequently be described based on FIG. 6.

As shown in FIG. 6, a work 117 placed in the first container 102 is transferred to the slider 115 by the robot 101 once the working has been performed. The work 117 is conveyed from the inside of the working area W to the outside. As a result, the container 102 is left empty.

When the container 102 becomes empty, an operator P who is outside of the working area W checks that the indicator lamp 113 is illuminated, opens the first door 104a, and withdraws the first container 102 out to the work delivery area 105. A subsequent work 118 is placed on the withdrawn first container 102 and pushed through the first door 104a. The operator then withdraws from the area, and subsequently closes the first door 104a. During this time, the robot performs a predetermined work in the area with the diagonal stripes.

The operator P cannot enter the area of the semicircular working area W shown with the diagonal stripes because that is where the robot is moving. However, the operator P can enter the area without the diagonal stripes.

When one working is finished, the position of the diagonal stripes is switched to the left of the diagram, and the second container 103 is withdrawn from the second door 104b.

The robot can thus be kept running continuously by alternately switching the position of the diagonal stripes.

However, the working device 100 described above requires a variety of elements comprising the first door 104a; the second door 104b; the first opening sensor 111 for detecting the opening and closing of the first door 104a; the second opening sensor 112 for detecting the opening and closing of the second door 104b; sensors 107, 109 for confirming safety; and indicator lamps 113, 114. The working device 100 thus inevitably becomes complicated. As a result, the cost of the working device 100 also increases.

Therefore, a working device and working method having a simple structure and low equipment cost is desirable.

### DISCLOSURE OF THE INVENTION

According to a first aspect of the present invention, there is provided a working device comprising: a robot for performing working on work which is comprised of a first work piece and a second work piece; and a protection fence surrounding the robot, characterized in that a second work piece transferring mechanism for transferring the second work piece from outside the protection fence to a working area of the robot.

The second work piece is transferred from outside of the protection fence to the inside or from the inside to the outside by the second work piece transferring mechanism. Specifically, an operator does not need to enter the inside of the protection fence. The robot can perform work on the first and second work pieces during this time.

Since an operator does not need to enter the inside of the protection fence, sensors or switches for detecting the operator can be omitted, and an inexpensive working device with a simple structure can be provided.

Preferably, the second work piece transferring mechanism comprises a rail provided through an opening formed in the protection fence, and a tray movably placed on the rail and adapted to carry the second work piece thereon, the tray having a front wall portion and a back wall portion sized and shaped to block the opening.

The second work piece transferring mechanism is provided with the front wall portion and the back wall portion, which are set to a size and shape that blocks the opening. As long as the opening in the protection fence is blocked by the front wall portion or the back wall portion, no concern will be presented that the hand of an operator or other object will pass through the protection fence via the opening.

According to a second aspect of the present invention, there is provided a working method using a robot for performing working on work comprised of a first work piece and a second work piece, which method comprises: a first working step wherein working is performed on the first work piece by a robot; a second work piece removal step wherein a processed second work piece, which is in a working area of the robot alongside the first working step, is transferred outside the protection fence; a second work piece introducing step wherein an unprocessed second work piece is transferred from outside the protection fence into the working area of the robot; and a second working step wherein work is performed on the second work piece by the robot when there is no overlap with the first working step, so that the first and second work pieces are continuously by the same robot.

The second working step wherein the robot performs work on the second work piece is provided when there is no overlap with the first working step, and the first and second work pieces can be continuously processed by the same robot. Therefore, the work rate of the robot can be increased, and the robot can be efficiently utilized.

### BRIEF DESCRIPTION OF THE DRAWINGS

FIG. 1 is a perspective view illustrating a working device according to the present invention;

FIG. 2 is a top plan view of the working device of FIG. 1;

FIGS. 3A to 3C are schematic views showing movements of a mechanism for transferring a second work piece;

FIG. 4 is a time chart showing a relationship between a robot, a first work piece, and the second work piece;

FIG. 5 is a schematic view of a conventional working device; and

FIG. 6 illustrates an operation of the conventional working device of FIG. 5.

### BEST MODE FOR CARRYING OUT THE INVENTION

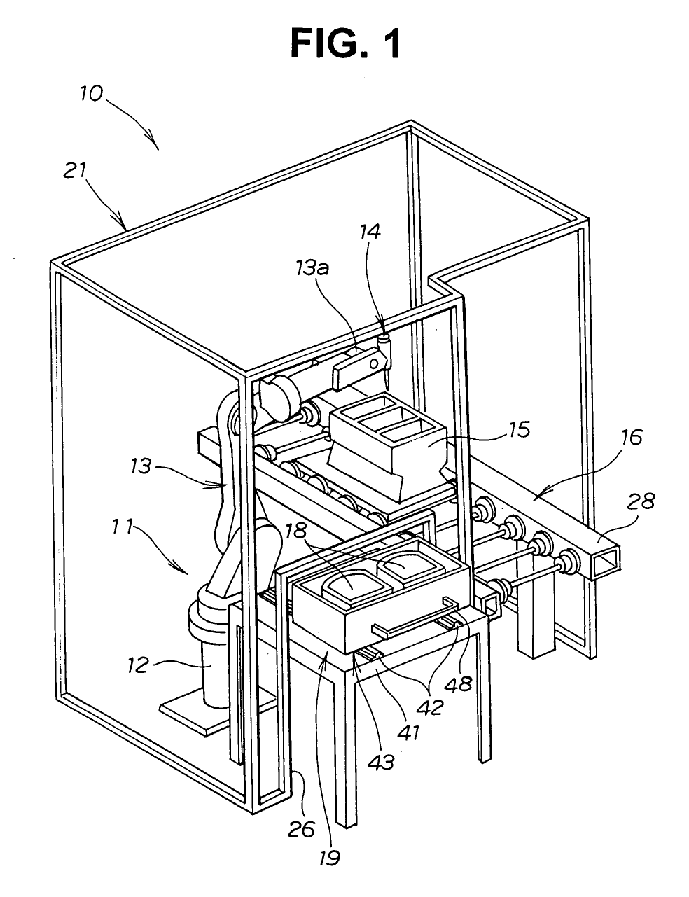

As shown in FIG. 1, a working device 10 comprises a robot 11; a sealant coating unit 14 that is attached to a distal end 13a of a robot arm 13; a first conveyer 16 that is provided around the robot 11; and a mechanism 19 for transferring a second work piece that is provided around the robot 11 and removes or introduces a second work piece 18; and a protection fence 21 that surrounds all of the robot 11, first conveyer 16, and mechanism 19 for transferring the second work piece.

Specifically, the working device 10 comprises the robot 11, which performs work on two types of work 15, 18 comprising a first work piece 15 and second work piece 18; and the protection fence 21 that surrounds the robot 11.

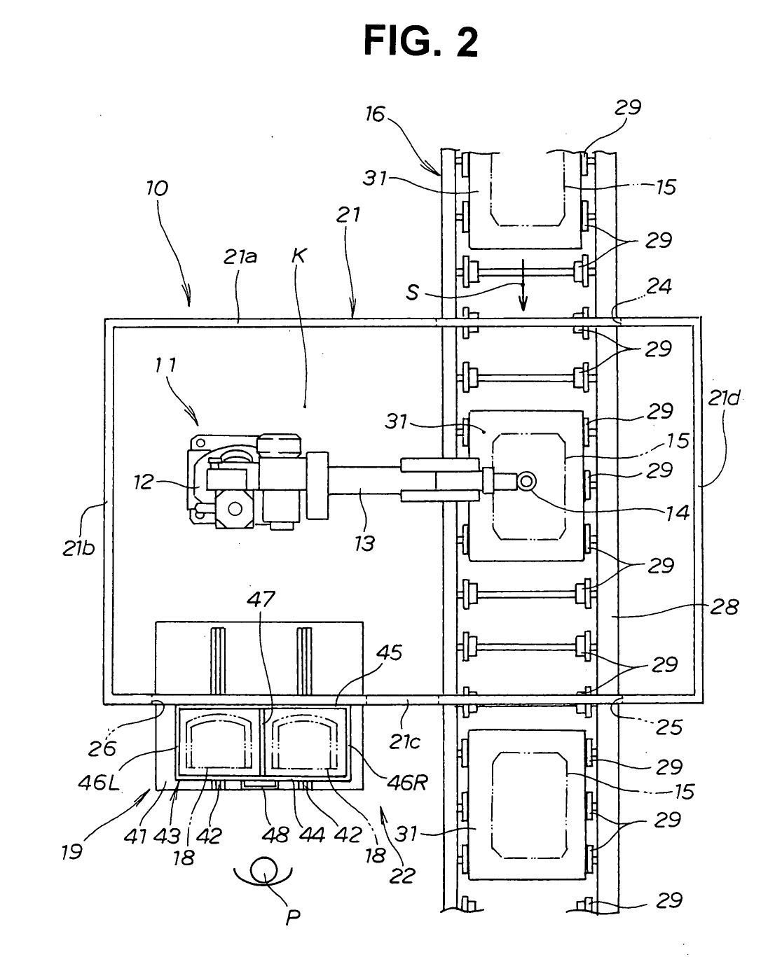

As shown in FIG. 2, the first conveyer 16 that conveys the first work piece 15 is provided in a working area K of the robot 11 surrounded by the protection fence 21. Also provided is the second work piece transferring mechanism 19, which transfers the second work pieces 18, 18 to the working area K.

The second work piece transferring mechanism 19 that carries the second work piece 18 and transfers it from beyond the protection fence 21 to the working area K of the robot 11 is established on the protection fence 21.

The robot 11 comprises a robot body 12; the robot arm 13, which extends from the robot body 12; and the sealant coating unit 14, which is provided to the distal end of the robot arm 13.

The robot 11 performs the work of applying the sealant on the first work piece 15 and the second work piece 18 using the sealing coating unit 14 while moving the robot arm 13 in the working area K within the protection fence 21.

The protection fence 21 is composed of four fences comprising first through fourth fences 21a, 21b, 21c, 21d. The third fence 21c is disposed facing the first fence 21a, and the fourth fence 21d is disposed facing the second fence 21b.

A first opening 24 and a second opening 25 through which the first conveyer 16 passes are provided to the first fence 21a and the third fence 21c. A third opening 26 wherein the second work piece transferring mechanism 19 passes through is provided to the third fence 21c. As a result, the first work piece 15 and second work piece 18 can be removed from or introduced to the working area K.

The first conveyer 16 comprises a frame 28, and a plurality of roller members 29 that are disposed on the frame 28. The roller members 29 act to transfer a plate-shaped pallet 31 in the direction of the arrow S shown in the drawing.

The second work piece transferring mechanism 19 comprises a base 41 provided through the third opening 26; rails 42, 42 laid on the base 41; and a tray 43 movably provided along the rails 42, 42. Specifically, the base 41 is provided crossing laterally through the third opening 26 and protruding inward and outward from the protection fence 21.

The tray 43 comprises a front wall portion 44 and a back wall portion 45 that are set to a size and shape to block the third opening 26; an operation portion 48 that is provided to the outer surface of the front wall portion 44 and that operates the tray 43; a left side wall portion 46L and a right side wall portion 46R that blocks the sides of the tray 43; and a separator plate 47 that separates and positions the two second work pieces 18, 18 placed on the tray 43.

The second work piece transferring mechanism 19 comprises the front wall portion 44 and the back wall portion 45. As long as the opening 22 of the protection fence 21 is blocked by the front wall portion 44 or the back wall portion 45, no concern will be presented that the hand of an operator or other object will pass through the protection fence 21 through the opening 22.

The operation of the working device described above will subsequently be described.

The first work piece 15 placed on the pallet 31 is conveyed into the protection fence 21 from the first opening 24 and reaches a predetermined position on the first conveyer 16. The robot 11 then begins applying the sealant to the predetermined position of the surface of the first work piece 15.

No concern will be presented that the robot 11 will come near the second work piece transferring mechanism 19 while the robot 11 is applying the sealant to the first work piece 15. Therefore, even when the tray 43 of the second work piece transferring mechanism 19 is transferred, the robot 11 will not cease working.

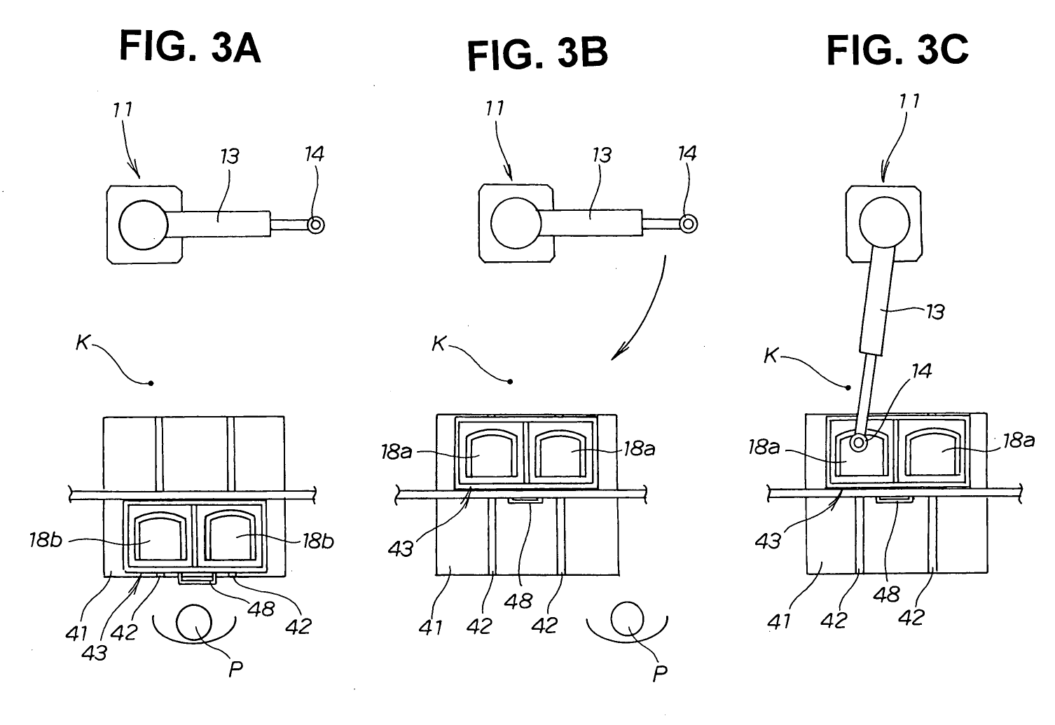

An operation of the second work piece transferring mechanism 19 will subsequently be described based on FIGS. 3A to 3C.

As shown in FIG. 3A, an operator P withdraws the tray 43 by gripping the operation portion 48 and removes the second work pieces 18b, 18b after processing (after the sealant has been applied) to the outside.

As shown in FIG. 3B, the operator P places the unprocessed second work pieces 18a, 18a into the tray 43, grips and pushes the operation portion 48, and transfers the second work pieces 18a, 18a to the working area K of the robot 11.

As shown in FIG. 3C, when a condition has been satisfied; i.e., the third opening 26 (FIG. 2) provided to the fence is closed by the front wall portion 44 of the tray 43, the work of applying the sealant to the second work pieces 18a, 18a is administered by the robot 11.

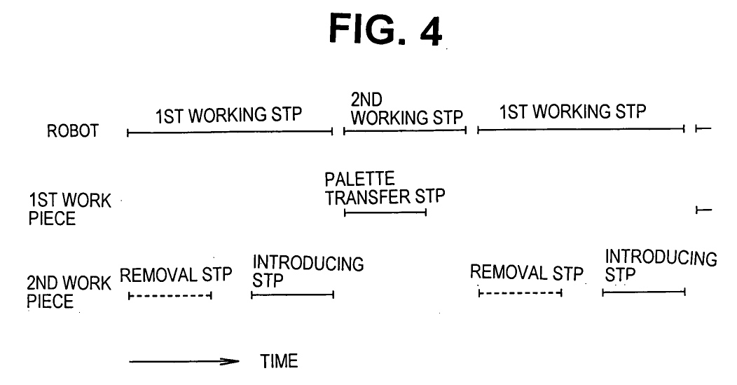

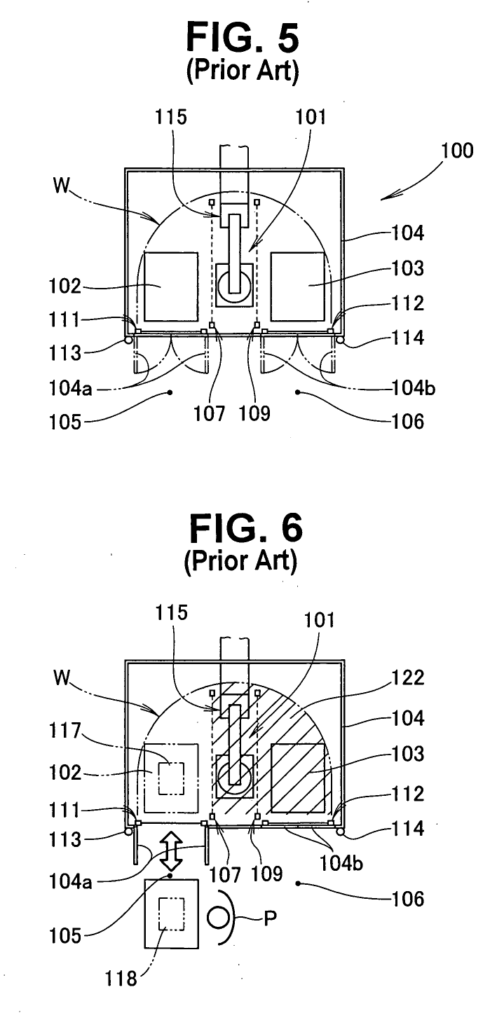

The time chart of the working device will be described now with reference to FIG. 4. As shown in FIG. 4, the robot performs, in alternating fashion, the first working step for performing work on the first work piece and the second working step for performing work on the second work piece.

The application of the sealant and other work is performed by the robot on the first work piece in the first working step. When the second working step is to be performed, the pallet is transferred, whereby the first work piece is transferred.

Work is performed on the second work piece by the robot during the second working step. When the first working step is to be performed, the introduction and removal of the second work piece is performed.

The idle time of the robot; i.e., when the robot is not performing the work of applying the sealant to the first work piece during the conveying of the first work piece or other such times, can be used for work on the second work piece.

Specifically, the second working step wherein the robot performs work on the second work piece is provided when there is no overlap with the first working step, and the first and second work piece can be continuously processed by the same robot. Therefore, the work rate of the robot can be increased, and the robot can be efficiently utilized.

In the present embodiment, the first work piece 15 (FIG. 2) is a cylinder block of an engine, the second work piece 18 (FIG. 2) is a small component used in the same engine, and both can be processed with a single sealant application unit. Furthermore, work on which a sealant has been applied must be installed before the sealant has solidified. It is not possible for the work to be “left alone after being made;” it must be installed promptly. The working device of the present invention is suitable for production under such conditions.

Furthermore, in the present embodiment, the working device is applied to a device for applying a sealant to a cylinder block; however, the working device can also be used for applying sealant to door members and small components in a vehicle body assembly step, and may be used in a step for applying sealant to a work in other common production lines.

Welding, bolt-fastening, and cutting work are other tasks that may be performed in addition to applying sealants.

### INDUSTRIAL APPLICABILITY

The present invention is suited to devices for applying a sealant to a cylinder block in an engine manufacturing step.

1. A working device comprising
a robot for performing working on work which is comprised of a first work piece and a second work piece; and
a protection fence surrounding the robot,
characterized in that a second work piece transferring mechanism for transferring the second work piece from outside the protection fence to a working area of the robot.

2. The working device of claim 1, wherein the second work piece transferring mechanism comprises a rail provided through an opening formed in the protection fence, and a tray movably placed on the rail and adapted to carry the second work piece thereon, the tray having a front wall portion and a back wall portion sized and shaped to block the opening.

3. A working method using a robot for performing working on work comprised of a first work piece and a second work piece, comprising:
a first working step wherein working is performed on the first work piece by a robot;
a second work piece removal step wherein a processed second work piece, which is in a working area of the robot alongside the first working step, is transferred outside the protection fence;
a second work piece introducing step wherein an unprocessed second work piece is transferred from outside the protection fence into the working area of the robot; and
a second working step wherein work is performed on the second work piece by the robot when there is no overlap with the first working step, so that the first and second work pieces are continuously by the same robot.
